(19) United States
(12) Patent Application Publication
(10) Pub. No.: US 2023/0334297 A1
(43) Pub. Date: Oct. 19, 2023

(54) INFORMATION PROCESSING APPARATUS, INFORMATION PROCESSING METHOD, AND COMPUTER READABLE MEDIUM

(71) Applicant: NEC Corporation, Minato-ku, Tokyo (JP)

(72) Inventors: Daniel Georg Andrade Silva, Tokyo (JP); Yuzuru Okajima, Tokyo (JP)

(73) Assignee: NEC Corporation, Minato-ku, Tokyo (JP)

(21) Appl. No.: 18/018,373

(22) PCT Filed: Aug. 28, 2020
(86) PCT No.: PCT/JP2020/032785

§ 371 Date: Jan. 27, 2023

(51) Int. Cl. G06N 3/047; G06N 3/048

(52) U.S. Cl. CPC G06N 3/047; G06N 3/048

(57) ABSTRACT

An object of the present disclosure is to provide an information processing apparatus, an information processing method, and a non-transitory computer readable medium capable of producing an accurate output to detect outlier(s). An information processing apparatus according to the present disclosure includes at least one memory configured to store instructions; and at least one processor configured to execute the instructions to: calculate each probability of each data point being an outlier by using a temperature parameter t, wherein t>0; lower the temperature parameter t towards 0 with a plural of step; and output the probability.

### TECHNICAL FIELD

The present disclosure relates to an information processing apparatus, an information processing method, and a non-transitory computer readable medium.

### BACKGROUND ART

There are many purposes to improve the machine learning by detecting outliers. For example, NPL 1 introduce new approach of differentiative sorting for detecting outliers.

### CITATION LIST

### Non Patent Literature

NPL 1: Blondel et al., “Fast Differentiable Sorting and Ranking”, In Proceedings of the International Conference on Machine Learning, 2020.

### SUMMARY OF INVENTION

### Technical Problem

However, the method described in NPL 1 may produce an inaccurate output when there is an outstanding outlier in input data.

An object of the present disclosure is to provide an information processing apparatus, an information processing method, and a non-transitory computer readable medium capable of producing an accurate output to detect outlier(s).

### Solution to Problem

In a first example aspect, an information processing apparatus includes: a probability calculation means for calculating each probability of each data point being an outlier by using a temperature parameter t>0; and an adjustment means for lowering the temperature parameter t towards 0 with a plural of step and outputs the probability.

In a second example aspect, an information processing method includes: calculating each probability of each data point being an outlier by using a temperature parameter t>0; and lowering the temperature parameter t towards 0 with a plural of step and outputs the probability.

In a third example aspect, a non-transitory computer readable medium storing a program to causes a computer to execute: calculating each probability of each data point being an outlier by using a temperature parameter t>0; and lowering the temperature parameter t towards 0 with a plural of step and outputs the probability.

### Advantageous Effects of Invention

According to the present disclosure, it is possible to provide an information processing apparatus, an information processing method, and a non-transitory computer readable medium capable of producing an accurate output to detect outlier(s).

### BRIEF DESCRIPTION OF DRAWINGS

FIG. 1 is a figure illustrating example data with 4 outliers, and 16 inliers sampled from a gaussian distribution;

FIG. 2 is a figure illustrating an estimation of a soft-sort method;

FIG. 3 is a configuration diagram illustrating a structure of a first example embodiment of the present disclosure;

FIG. 4 is a conceptual diagram illustrating steps of a second example embodiment of the present disclosure;

FIG. 5 is a figure illustrating a one example of Algorithm of the second example embodiment of the present disclosure;

FIG. 6 is a figure illustrating other example of Algorithm of the second example embodiment of the present disclosure;

FIG. 7 is a figure illustrating an estimation of the second example embodiment of the present disclosure; and

FIG. 8 is a configuration diagram of an information processing apparatus according to a respective embodiment.

### DESCRIPTION OF EMBODIMENTS

(Outline of Related Art)

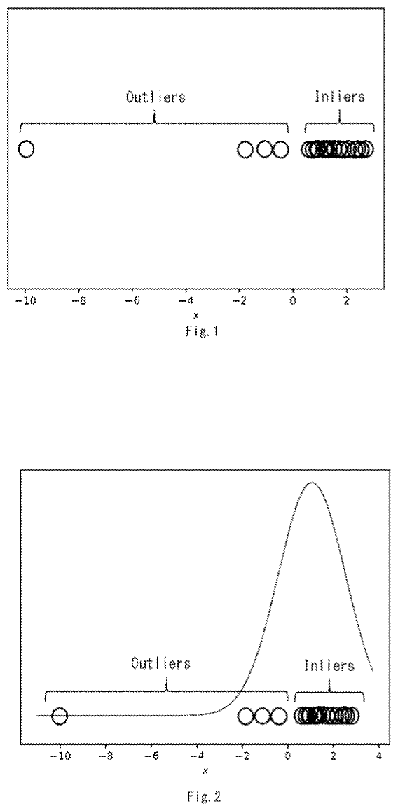

Prior to explaining embodiments according to this present disclosure, an outline of related art is explained with reference to FIGS. 1 to 2.

Let us denote training data as follows:

{xᵢ}ᵢ₌₁ⁿ.

We assume that we have an upper bound on the number of outliers k, with k<<n. For example, k=n*1%.
Let denote the index set of outliers.

\hat{B}⊆{1, . . . ,n}

Least trimmed squares suggests to identify the set of outliers using the following objective:

$$\hat{B} = {arg max}_{B , \vert B \vert = k} {max}_{θ} log p ( {X}_{- B} \vert \hat{θ} ) + log p ( θ ) ,$$

where we denote by

log p(X−B|\hat{θ})

the log likelihood of the data except the set B, i.e.

$$log p ( {X}_{- B} \vert \hat{θ} ) = {\sum }_{x ∈ X \backslash B} log p ( x \vert \hat{θ} ) .$$

The optimization problem, as suggest used in NPL 1, assumes a Gaussian distribution for the likelihood p(x|θ), and a uniform (improper) prior for p(θ).

Furthermore, let us define

[symbol]

ᵢ:=log p(xᵢ|θ)

Trimmed least squares optimizes the following objective using gradient

$${max}_{θ} \frac{1}{n - k} {\sum }_{i = k + 1}^{n} {s ( ℓ )}_{i} + p ( θ ) ,$$

where s is the sort-operation which sorts the vector

[symbol]

=( [symbol] ₁, [symbol] ₂, . . . , [symbol] ₙ)

in ascending order. However, the sort operation is a piece-wise linear function with no derivative at its edges. Therefore, optimization with sub-gradients can be unstable and/or lead to slow convergence.

As a consequence, NPL 1 proposed to replace the sorting operation with a soft-sort operation s_{ε}:

$${max}_{θ} \frac{1}{n - k} {\sum }_{i = k + 1}^{n} {{s}_{ϵ} ( ℓ )}_{i} + p ( θ ) ,$$

where ε controls the smoothness, and for ε→0, we recover the original sort operation. On the other hand, for ε→∞, returns the mean value in each element that is

$$( \frac{1}{n} {\sum }_{i = 1}^{n} {ℓ}_{i} , … , \frac{1}{n} {\sum }_{i = 1}^{n} {ℓ}_{i} ) .$$

From this it is also apparent that the value of

Σᵢ₌ₖ₊₁ⁿS_{ϵ}( [symbol] )ᵢ

actually changes for different values of ε.

(Problems to be solved by the disclosure) A Problem of the method in NPL 1 is that if one entry Iⱼ has a very large magnitude, all entries after soft-sort will approach a value that is close to the mean. More formally,

$$If \vert {ℓ}_{j} \vert \to ∞ , then ∀ i : {{s}_{ϵ} ( ℓ )}_{i} \to \frac{{\sum }_{i = 1}^{n} {ℓ}_{i}}{n} .$$

This has the consequence, that the trimmed log-likelihood sum approaches the ordinary log-likelihood sum, up to a constant factor:

$${\sum }_{i = k + 1}^{n} {{s}_{ϵ} ( ℓ )}_{i} \to \frac{( n - k )}{n} {\sum }_{i = 1}^{n} {ℓ}_{i} .$$

However, it is well known that the ordinary log-likelihood sum is sensitive to outliers. As a result, using the trimmed log-likelihood sum from the soft-sort can also be sensitive to outliers.

As an example, consider the following data: The inliers are 16 samples from a normal distribution with mean 1.5 and standard deviation 0.5. Additionally, there are four outliers: 3 samples from a normal distribution with mean −1.5 and standard deviation 0.5, and 1 sample at point −10.0. The data is shown in FIG. 1. FIG. 1 shows example data with 4 outliers, and 16 inliers sampled from a gaussian distribution. Inliers are shown on the right side and outliers are shown on the left side in FIG. 1.

However, the soft-sort method is influenced by the outlier −10.0, and its estimate of the inlier distribution is shifted towards left as shown in FIG. 2. FIG. 2 shows an estimation of the soft-sort method (with ε=0.5). Inliers are shown on the right side and outliers are shown on the left side in FIG. 2, and the curve in FIG. 2 shows the probability density function of the inliers.

The estimate of the parameters θ=(μ, σ²) using the soft-sort method are

\hat{μ}=1.05,

\hat{σ}²=2.16.

Classifying the four data points with the lowest probability density function as outliers, the soft-sort method wrongly classifies two data points as outliers.

As an obvious remedy one might consider decreasing E towards 0, with decreasing number of gradient descent iterations. However, since the objective value

Σᵢ₌ₖ₊₁ⁿS_{ϵ}( [symbol] )ᵢ

changes for different values of ε, this changes the influence of the prior distribution p(θ).

Example embodiments of the present disclosure are described in detail below referring to the accompanying drawings. These embodiments are applicable to apparatus producing an accurate output to detect outlier(s). For example, the method shown below can determine outliers in a training data set.

### First Example Embodiment

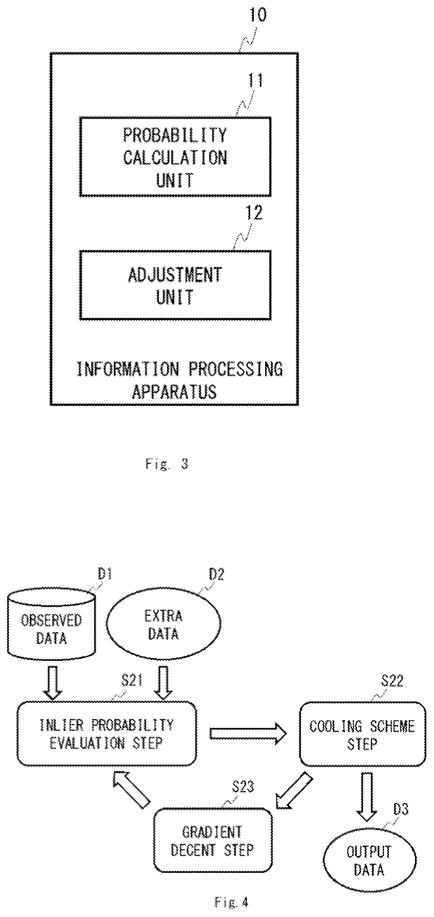

First, an information processing apparatus 10 according to a first example embodiment is explained with reference to FIG. 3.

Referring to FIG. 3, the first example embodiment of the present disclosure, an information processing apparatus 10, includes a probability calculation unit (probability calculation means) 11 and an adjustment unit (adjustment means) 12. For example, the information processing apparatus 1 can be used for the machine learning.

The probability calculation unit 11 calculates each probability of each data point being an outlier by using a temperature parameter t>0. The data points are included input data, which may be stored in the information processing apparatus or sent from outside the information processing apparatus 10. The probability is a value and shows the data point thereof is an outlier or inlier. The temperature parameter t means the one used in the study of statistics in general.

The adjustment unit 12 lowers t towards 0 with a plural of step and outputs the probability. It should be noted that the adjustment unit 12 may make the temperature parameter 0 in the final step, however, it may make the temperature parameter a small value (close to 0) in the final step. The small value is not limited when it is apparent to distinguish whether the probability of the output is the outlier or inlier.

The structure shown in FIG. 3 can be performed by software and hardware installed in an information processing apparatus 11. More specific structure will be explained.

As mentioned above, the probability calculation unit 11 uses the temperature parameter t to calculate the probability and the adjustment unit 12 lowers the temperature parameter t towards 0 with a plural of step and outputs the probability. Therefore, even if there is an outstanding outlier in input data, the influence of the outlier decreases during the steps and the output is not so much affected by the outlier. As a consequence, the information processing apparatus 10 can produce an accurate output to detect outlier(s).

### Second Example Embodiment

First, a second example embodiment of the disclosure is described below referring to the accompanying drawings. This embodiment shows the best modes for carrying out the disclosure.

The information processing apparatus 10 in this embodiment includes the probability calculation unit 11 and the adjustment unit 12 in FIG. 3. The elements in the information processing apparatus 10 can work as the first example embodiment shows, however, they can work in more elaborate way as shown below.

Before explaining detailed procedures of the second example embodiment, some details should be explained. The proposed disclosure calculates a weight for each sample which is guaranteed to be between 0 and 1. Each sample's weight is multiplied with its log-likelihood value. The weights are controlled by a temperature parameter which control the smoothness of the optimization function. The temperature parameter is decreased during the gradient descent steps to ensure that influence of outliers decreases towards 0.

We derive our proposed disclosure as follows. Let

wᵢ∈{0,1}

be the indicator whether sample i is an inlier (wᵢ=1), or not (wᵢ=0). Finding the set of outliers is equivalent to optimizing the following objective jointly over

w∈{0,1}ⁿ

and θ:

$$log p ( θ ) + {\sum }_{i = 1}^{n} {w}_{i} log p ( {x}_{i} \vert θ )$$

$$subject to {\sum }_{i} {w}_{i} = n - k ,$$

where k is the number of outliers which are assumed to be given. However, this is a combinatorial hard problem.

We suggest the following continuous relaxation of the problem: Define

[symbol]

ᵢ:=log p(xᵢ|θ)

and set

$${w}_{i} := σ ( \frac{1}{t} ( {ℓ}_{i} - q ) ) \qquad ( 1 )$$

where q is the τ-quantile of

{ [symbol] ᵢ}ᵢ₌₁ⁿ,

with τ being the expected ratio of outliers, i.e. τ=k/n, and t>0 is a temperature parameter. Consequently, our method solves the following optimization problem

$${arg max}_{θ} log p ( θ ) + {\sum }_{i = 1}^{n} n ( 1 - τ ) \frac{{w}_{i}}{{\sum }_{j} {w}_{j}} log p ( {x}_{i} \vert θ ) .$$

The core steps of our method are illustrated in FIG. 4 and are explained in the following. The core steps are processed by the information processing apparatus 10.

The inlier probability evaluation step S21 in FIG. 4 was done by the probability calculation unit 11. In order to separate outliers and inliers, we introduce the inlier weight wᵢ as defined in Equation (1). We require wᵢ to be bounded between 0 and 1, and as such, can be interpreted as the probability that sample i is an inlier. Conversely, 1-wᵢ is considered as the probability that sample i is an outlier.

In the inlier probability evaluation step S21, the probability calculation unit 11 takes observed data D1 (sample data) and extra data D2. The observed data D1 includes the training data as follows:

{xᵢ}ᵢ₋₁ⁿ.

The extra data D2 includes information of the number of outliers in the observed data D1. In other words, it shows that there are k outliers in the observed data D1. Furthermore, The extra data D2 includes information of the specification of likelihood p(x|B) and a uniform prior for p(θ) Consequently, the probability calculation unit 11 takes as input the log-likelihood of a sample.

Based on the data, the probability calculation unit 11 calculates the probability as a sigmoid function for each sample. Each probability is parameterized with the temperature t and the threshold parameter q. In addition, the threshold parameter q depends on the number of outliers specified by the user.

The probability calculation unit 11 outputs a probability which is below 0.5 for the samples which have a lower log-likelihood than the k+1-th lowest sample, and a probability which is larger than 0.5 for the remaining samples. The temperature parameter t controls how far away the probabilities are from 0.5. For a high temperature value, all probabilities will be close to 0.5. On the other hand, for a low temperature value, all probabilities will be either close to 0 or 1.

A cooling scheme step S22 in FIG. 4 was done by the adjustment unit 12. In order to (1) clearly identify the outliers using wᵢ, and (2) reduce the influence of outliers on the training of parameters θ, we introduce a cooling scheme for lowering t towards 0. The lowering t depends on a change of a loss function and/or number of iterations from S21 to S23 in FIG. 4. The cooling scheme starts with some high value for t, and then gradually lowers t each time a certain number of gradient descent steps has passed, until t=0 (or very close to 0).

With increasing number of gradient descent steps S23 in FIG. 4, we propose to lower the temperature parameter t. For example, we might lower the temperature using an exponential cooling scheme as described in the following.

Let us define

$${f}_{t} ( θ ) := log p ( θ ) + {\sum }_{i = 1}^{n} n ( 1 - τ ) \frac{{w}_{i}}{{\sum }_{j} {w}_{j}} log p ( {x}_{i} \vert θ ) .$$

Furthermore, we specify maximal and minimal values for the temperature parameter. For example,

MAX TEMPERATURE=100.0 and MIN TEMPERATURE=0.01.

Furthermore, we specify a parameter ε to determine convergence to a (local) optimum of the objective function ƒₜ(θ) For example, ε=0.01.

The exponential cooling scheme is given by Algorithm 1, which is shown in FIG. 5.

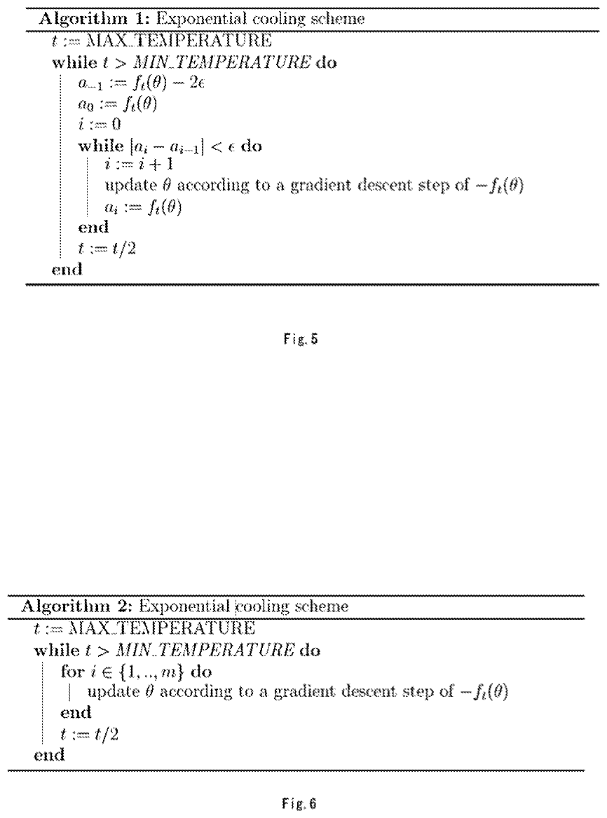

Alternatively, we might simply specify the number of gradient descent steps in the inner loop, by some parameter m. For example, m=100. The exponential cooling scheme then simplifies to Algorithm 2, which is shown in FIG. 6.

After the final cooling scheme is finished, the adjustment unit 12 outputs the output data D3, which includes the possibilities of every sample. The possibilities are indicator variables wᵢ (i=1, 2, . . . , n). wᵢ is 1 when xᵢ is an inlier, while wᵢ is 0 when xᵢ is an outlier.

### EXAMPLE

In the following, we give an example showing the effect of the disclosure. In particular, we consider the same data as before. (The inliers are 16 samples from a normal distribution with mean 1.5 and standard deviation 0.5. Additionally, there are four outliers: 3 samples from a normal distribution with mean −1.5 and standard deviation 0.5, and 1 sample at point −10.0. The data points, ranging from −10 to 2.7, are shown in FIG. 1.)

In Table 1, we show the weights of each data point learned for a specify temperature. The weights of each data point are show in the same order as the data points (i.e. starting from the data point with value −10 till the data point with value 2.7). Table 1 shows example output of the inlier weights wᵢ from the proposed method for different temperature parameters t. Weights of each data point are shown in the same order as the data points' values. Entries of the 10th to 15th data point are omitted ( . . . ) for clarity, but also converge to the correct value.

TABLE 1

| | | | | | | | | | | | | | | | |
|---|---|---|---|---|---|---|---|---|---|---|---|---|---|---|---|
| t = 100 | 0.47 | 0.5 | 0.5 | 0.5 | 0.55 | 0.5 | 0.5 | 0.5 | 0.5 | . . . | 0.5 | 0.5 | 0.5 | 0.5 | 0.5 |
| t = 6.25 | 0.0 | 0.36 | 0.44 | 0.49 | 0.55 | 0.55 | 0.55 | 0.56 | 0.56 | . . . | 0.55 | 0.53 | 0.53 | 0.51 | 0.51 |
| t = 3.13 | 0.0 | 0.05 | 0.2 | 0.4 | 0.67 | 0.68 | 0.69 | 0.72 | 0.72 | . . . | 0.72 | 0.68 | 0.66 | 0.62 | 0.6 |
| t = 1.56 | 0.0 | 0.0 | 0.07 | 0.31 | 0.8 | 0.81 | 0.82 | 0.86 | 0.86 | . . . | 0.86 | 0.82 | 0.79 | 0.72 | 0.69 |
| t = 0.39 | 0.0 | 0.0 | 0.0 | 0.05 | 0.99 | 0.99 | 1.0 | 1.0 | 1.0 | . . . | 1.0 | 1.0 | 0.09 | 0.97 | 0.95 |
| t = 0.01 | 0.0 | 0.0 | 0.0 | 0.0 | 1.0 | 1.0 | 1.0 | 1.0 | 1.0 | . . . | 1.0 | 1.0 | 1.0 | 1.0 | 1.0 |

Initially, the proposed method starts with temperature t=100, and then goes down till t=0.012. The final estimate of the parameters θ=(μ, σ²) using the proposed method are

\hat{μ}=1.05,

\hat{σ}²=2.16.

The outliers detected by the proposed method are shown in FIG. 7. The curve in FIG. 7 shows the probability density function of the inliers. As can be seen, the proposed method correctly identifies all outliers. Furthermore, compared to the example in FIG. 2, the probability density function becomes more correct.

As explained above, the proposed disclosure can decrease the influence of outliers on the objective function while guaranteeing an objective function which is sufficiently smooth to optimize via gradient descent methods.

In detail, the probability calculation unit 11 uses the temperature parameter t to calculate the probability and the adjustment unit 12 lowers the temperature parameter t towards 0 with gradient descent steps and outputs the probability. Therefore, the proposed disclosure can decrease the influence of outliers and produce an accurate output to detect outlier(s).

Furthermore, the probability calculation unit 11 can use the log-likelihood of each data point besides the temperature parameter t to calculate the probability. Therefore, it is possible to make the calculation in the processes simple and lower the time needed for it.

Furthermore, the probability calculation unit 11 can use a pre-specified ratio of outliers besides the temperature parameter t to calculate the probability. Therefore, it is possible to make the combinatorial hard problem into the optimization problem for easiness.

Furthermore, the probability calculation unit 11 can set the probability as a sigmoid function for each data point. Therefore, it is easy to distinguish between inliers with outliers.

Furthermore, the adjustment unit 12 can keep the temperature parameter t constant till gradient descent converges, or a pre-specified number of gradient descent iterations pass. Also, the adjustment unit 12 can decrease the temperature parameter t exponentially after gradient descent converges, or a pre-specified number of gradient descent iterations pass. Therefore, it is possible to decrease the influence of outliers, because the temperature parameter t will eventually go to zero.

The proposed disclosure can be applied to various fields, because detecting outliers is important for various applications. For example, outliers can correspond to malicious behavior of a user, and the detection of outliers can prevent cyber-attacks. Another, application is the potential to analyze and improve the usage of training data for increasing the prediction performance of various regression tasks. For example, wrongly labeled samples can deteriorate the performance of a classification model.

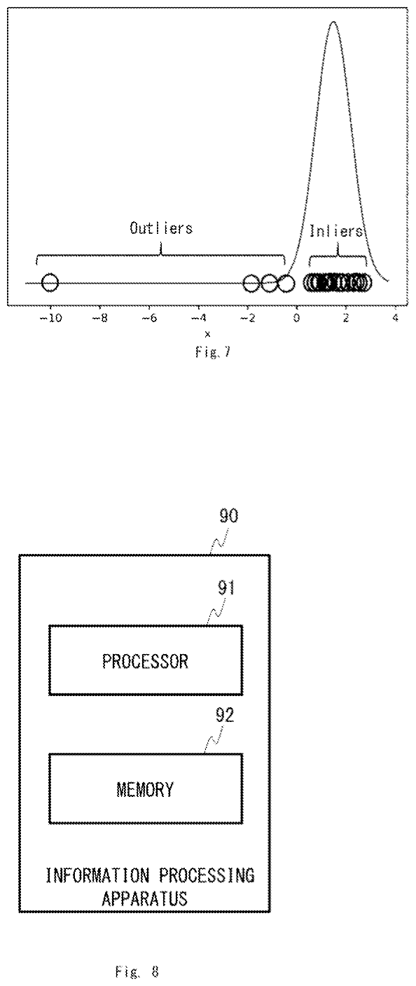

Next, a configuration example of the information processing apparatus explained in the above-described plurality of embodiments is explained hereinafter with reference to FIG. 8

FIG. 8 is a block diagram showing a configuration example of the information processing apparatus. As shown in FIG. 8, the information processing apparatus 90 includes a processor 91 and a memory 92.

The processor 91 performs processes performed by the information processing apparatus 90 explained with reference to the sequence diagrams and the flowcharts in the above-described embodiments by loading software (a computer program) from the memory 91 and executing the loaded software. The processor 91 may be, for example, a microprocessor, an MPU (Micro Processing Unit), or a CPU (Central Processing Unit). The processor 91 may include a plurality of processors.

The memory 92 is formed by a combination of a volatile memory and a nonvolatile memory. The memory 92 may include a storage disposed apart from the processor 91. In this case, the processor 91 may access the memory 92 through an I/O interface (not shown).

In the example shown in FIG. 8, the memory 92 is used to store a group of software modules. The processor 91 can perform processes performed by the information processing apparatus explained in the above-described embodiments by reading the group of software modules from the memory 92 and executing the read software modules.

As explained above with reference to FIG. 8, each of the processors included in the information processing apparatus in the above-described embodiments executes one or a plurality of programs including a group of instructions to cause a computer to perform an algorithm explained above with reference to the drawings.

Furthermore, the information processing apparatus 90 may include the network interface. The network interface is used for communication with other network node apparatuses forming a communication system. The network interface may include, for example, a network interface card (NIC) in conformity with IEEE 802.3 series. The information processing apparatus 90 may receive the input feature maps or send the output feature maps using the network interface.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described embodiments and can be modified as appropriate without departing from the spirit and scope of the present disclosure.

### INDUSTRIAL APPLICABILITY

The present disclosure is applicable to detecting outliers in the field of computer system.

### REFERENCE SIGNS LIST

10 information processing apparatus
11 probability calculation unit
12 adjustment unit

What is claimed is:

1. An information processing apparatus comprising:
at least one memory configured to store instructions; and
at least one processor configured to execute the instructions to:
calculate each probability of each data point being an outlier by using a temperature parameter t, wherein t>0;
lower the temperature parameter t towards 0 with a plural of step; and
output the probability.

2. The information processing apparatus according to claim 1,
wherein the at least one processor is further configured to use log-likelihood of each data point besides the temperature parameter t to calculate the probability.

3. The information processing apparatus according to claim 1,
wherein the at least one processor is further configured to use a pre-specified ratio of outliers besides the temperature parameter t to calculate the probability.

4. The information processing apparatus according to claim 1,
wherein the at least one processor is further configured to set the probability as a sigmoid function for each data point.

5. The information processing apparatus according claim 1,
wherein the at least one processor is further configured to keep the temperature parameter t constant till gradient descent converges, or a pre-specified number of gradient descent iterations pass.

6. The information processing apparatus according to claim 1,
wherein the at least one processor is further configured to decrease the temperature parameter t exponentially after gradient descent converges, or a pre-specified number of gradient descent iterations pass.

7. An information processing method performed by a computer comprising:
calculating each probability of each data point being an outlier by using a temperature parameter t, wherein t>0;
lowering the temperature parameter t towards 0 with a plural of step; and
outputting the probability.

8. A non-transitory computer readable medium storing a program for causing a computer to execute:
calculating each probability of each data point being an outlier by using a temperature parameter t, wherein t>0;
lowering the temperature parameter t towards 0 with a plural of step; and
outputting the probability.
